(19) United States
(12) Patent Application Publication
(10) Pub. No.: US 2026/0258699 A1
(43) Pub. Date: Sep. 3, 2026

(54) END CAP FOR VANE OF A ROLLER SHUTTER

(71) Applicant: LOUVER-LITE LIMITED, Hyde (GB)

(72) Inventor: Andrew Greening, Hyde (GB)

(73) Assignee: LOUVER-LITE LIMITED, Hyde (GB)

(21) Appl. No.: 19/163,633

(22) PCT Filed: Mar. 9, 2023
(86) PCT No.: PCT/GB2023/050559

§ 371 Date: Sep. 9, 2025

(51) Int. Cl. E06B 9/06

(52) U.S. Cl. CPC E06B 9/0638

(57) ABSTRACT

An end cap for a shading vane, the end cap including a plunger and a plunger housing; wherein the plunger is slidably coupled to the plunger housing, the plunger has a projecting configuration in which a boss portion of the plunger projects from the housing, and the plunger has a retracted configuration in which the boss portion of the plunger is located within the plunger housing; the plunger is biased towards the projecting configuration; the housing is defined by one or more housing walls; and wherein the plunger includes at least one leg; the or each leg includes a lug at a distal end thereof; and the or each lug engages a stop surface defined by one or more of the housing when the plunger is in its projecting configuration.

The present invention relates to end caps for shading assemblies, such as louvre blinds and shutters. It also relates to louvres and shutter vanes including such end caps and to shutter systems including such vanes.

Shutter systems often comprise solid vanes which cannot be manipulated during the assembly of the shutter. Similarly, shutter systems that include hollow vanes with fixed end caps or plates also are not manipulable during the assembly of the shutter. In such cases, it is necessary to align all of the vanes with one vertical side element (stile) of the shutter and then try to align all of the vanes with the opposing vertical side element (stile). This is a difficult and time-consuming process.

The present invention addresses this issue.

According to a first aspect of the invention, there is provided an end cap for a shading vane or louvre, the end cap including a plunger and a plunger housing; wherein the plunger is slidably coupled within the plunger housing, the plunger defines a projecting configuration in which a boss portion of the plunger projects from the housing, and the plunger defines a retracted configuration in which the boss portion of the plunger is located within the plunger housing; and wherein the plunger is biased towards the projecting configuration.

In this way, the frame of the window blind or shutter may be pre-assembled first. One end of a shading vane or louvre may then be inserted into an aperture defined by one of the vertical stiles. The opposite end of the shading vane or louvre includes the end cap of the invention. The plunger is urged into its retracted configuration against the biasing force. It may then be aligned with an aperture defined by the opposite vertical stile. When aligned with the aperture, the plunger is released, whereupon it is urged into its projecting configuration by the biasing force. When in its projecting configuration, the boss portion is located within the aperture defined by the opposite vertical stile.

The ability to pre-assemble the shutter or window blind frame before the insertion of the louvres or vanes makes the assembly of the window blind or shutter easier.

According to an embodiment of the invention, the boss portion of the plunger is cylindrical. A cylindrical boss portion located within an aperture having a circular cross-section permits the louvre or vane to rotate relative to the window blind or shutter frame. Thus, the body which defines the aperture functions as a bearing for the boss portion.

The biasing force for the plunger is suitably provided by a spring. For example, a leaf spring. In the context of the present invention, a leaf spring should be understood to refer to a resiliently deformable strip, wherein the biasing force is exerted in a direction which is perpendicular to the longitudinal axis of the strip. The leaf spring is suitably secured at each end to a respective mounting.

In a further embodiment of the invention, the plunger housing includes opposed walls and the leaf spring is connected at one end to one of the opposed walls and is connected at its opposite end to the other of the opposed walls. Thus, the leaf spring suitably extends between the opposed walls of the plunger housing. Where the opposed walls are parallel to each other, the biasing force is exerted in a direction that is substantially parallel to the planes of the opposed walls.

Suitably, the plunger housing defines a cavity within which the plunger is located. Optionally, the cavity has a cross-section which is circular (i.e., a cylindrical cavity) or rectangular. The cavity suitably defines a longitudinal axis. Thus, the plunger may slide axially relative to the cavity.

In a yet further embodiment of the invention, the plunger includes at least one leg; the or each leg includes a lug at a distal end thereof; and the or each lug engages a stop surface of one or more walls which define the plunger housing when the plunger is in its projecting configuration. Such an arrangement limits the distance by which the plunger may extend from the plunger housing. Accordingly, the leg and lug arrangement constrains the outward displacement of the plunger from the plunger housing.

It will be appreciated that the length of the leg determines the distance by which the boss portion of the plunger may extend from the plunger housing. In certain embodiments of the invention, the plunger includes a plunger body, the boss portion of the plunger extends from the plunger body in a first direction, and the or each leg extends from the plunger body in a second direction which is substantially opposite to the first direction.

In embodiments in which the end cap includes a biasing element, such as a leaf spring, the biasing element may limit the axial displacement of the plunger within the plunger housing in the opposite direction. Thus, the biasing element may be located at an end of the plunger which is opposite to the boss portion.

In embodiments in which the plunger housing defines a rectangular aperture, the plunger may include a rectangular body portion. In such embodiments, the boss portion may extend from a first side of the rectangular body and the or each leg may extend from a second, opposite side of the rectangular body. Optionally, the plunger may include a leg which extends from at least one corner portion of the rectangular body. For example, it may include two legs, wherein each leg extends from an opposite corner of the body. Alternatively, it may include four legs, wherein each leg extends from a respective corner of the body.

The end cap suitably includes one or more coupling elements via which the end cap may be secured to a body portion of a respective louvre or shutter vane. In such embodiments, the boss portion of the plunger suitable projects away from the main body portion of the louvre or shutter vane.

According to a second aspect of the invention, there is provided a shutter vane or a louvre including a main body portion, a first end cap at one end thereof and a second end cap at the opposite end thereof, wherein the first end cap is as defined anywhere herein in connection with the first aspect of the invention.

The second end cap may be as defined anywhere herein in connection with the first aspect of the invention, or it may include a fixed boss portion. Suitably, the second end cap includes a substantially planar end cap body portion and the fixed boss portion extends outwardly from the substantially planar end cap body portion.

The main body portion of the shutter vane or louvre may be a hollow body. In other words, the main body portion may define a cavity therein. The main body portion may have a cross-section which is oval in shape or the cross-section may be aerofoil-shaped or teardrop-shaped.

In an embodiment of the second aspect of the invention, at least one of the end caps forms a friction fit with the main body portion. Suitably, both of the end caps form a friction fit with the main body portion. For example, the first and/or second end caps may include one or more coupling elements and the or each coupling element may be located within a cavity defined by the main body portion. Suitably, the or each coupling element engages an inwardly facing surface of the main body portion and forms a friction fit therewith.

According to a third aspect of the invention, there is provided a shutter including a plurality of vanes as defined anywhere herein in connection with the second aspect of the invention, wherein the shutter includes opposed vertical side elements (sometimes referred to as “stiles”); the opposed vertical side elements each define a linear array of apertures; and a boss portion of the first end cap is located within an aperture defined by a first one of the vertical side elements and a boss portion of the second end cap is located within a corresponding aperture defined by a second one of the vertical side elements. In this way, one end of each vane may be rotatably coupled to the first vertical side element and the opposite end of the vane may be rotatably coupled to the second vertical side element.

In an embodiment of the invention, the shutter comprises a shutter frame defined by the first and second vertical side elements, a top bar and a bottom bar. In such an arrangement, the top bar connects a top end of the first and second vertical side elements and the bottom bar connects a bottom end of the first and second vertical side elements to form a rectangular frame in which the top bar and bottom bar are parallel to each other. In such an arrangement, each of the vanes are suitably arranged parallel to the top and bottom bars. Similarly, each of the vanes is suitably arranged to rotate about a horizontal axis.

The skilled person will appreciate that the features described and defined in connection with the aspects of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawings in which:

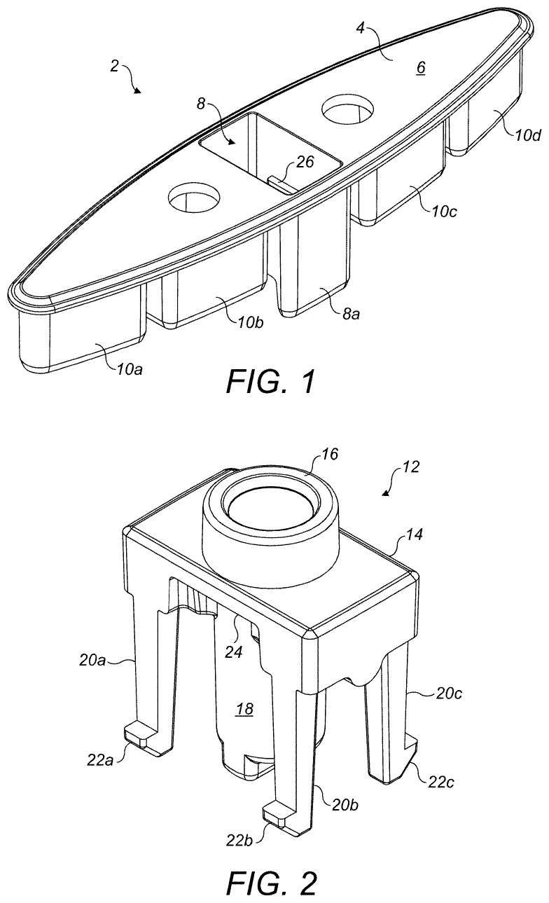

FIG. 1 shows a perspective view of an end cap according to the invention, with the plunger removed for clarity;

FIG. 2 shows a perspective view of a plunger for use with the end cap shown in FIG. 1;

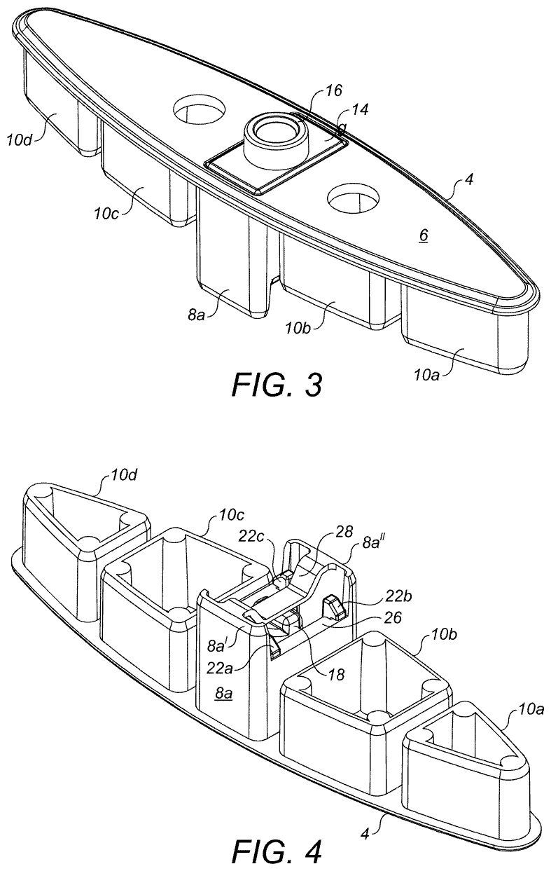

FIG. 3 shows a perspective view of the end cap shown in FIG. 1 including the plunger shown in FIG. 2;

FIG. 4 shows a different perspective view of the end cap shown in FIG. 3;

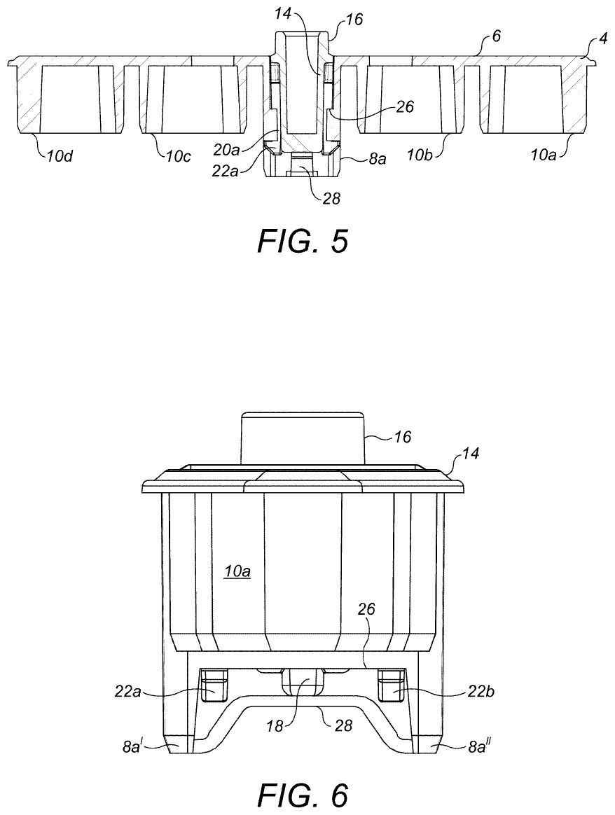

FIG. 5 shows a cross-sectional view through the end cap shown in FIGS. 3 and 4; and

FIG. 6 shows a side elevational view of the end cap shown in FIG. 1 and the plunger shown in FIG. 2.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIG. 1 shows an end cap 2 for use with a hollow louvre or shutter vane. The end cap 2 comprises an end cap body 4 having a substantially planar outwardly facing surface 6. The end cap body 4 includes a plunger housing body 8a which defines therein a rectangular plunger housing 8. Four engagement elements 10a, 10b, 10c, 10d are also carried by the end cap body 4, which extend rearwardly (i.e., in the opposite direction to the outwardly facing surface 6) from the body 4. In use, the engagement elements 10a, 10b, 10c, 10d engage respective surfaces of a hollow vane or louvre body to form a friction fit between the end cap 2 and the hollow vane or louvre.

FIG. 2 shows a plunger 12 comprising a plunger body 14 which is rectangular in shape. Extending forwards from the plunger body 14 is a cylindrical boss 16. Extending rearwards from the plunger body 14 is a spring contact element 18, which is in the form a cylindrical element. The function of the spring contact element 18 is described hereinbelow.

Finally, four legs 20a, 20b, 20c (only three are shown in FIG. 2) extend rearwards from the corners of the rectangular plunger body 14. Each of the legs 20a, 20b, 20c include at a distal end thereof an outwardly extending lug 22a, 22b, 22c.

The plunger 12 is sized to fit within the rectangular plunger housing 8 defined by the end cap body 4.

Finally, the plunger body 14 defines a pair of opposed stop surfaces 24 (only one of which is shown in FIG. 2). The stop surfaces 24 engage corresponding stop elements 26 which are carried within the rectangular plunger housing 8 defined by the plunger housing body 8a (shown in FIG. 1). The engagement of the stop elements 26 with the corresponding stop surfaces 24 limits the rearward displacement of the plunger 12 within the plunger housing 8.

FIGS. 3 and 4 show the plunger 12 located within the plunger housing 8 defined by the rectangular plunger housing body 8a. In these figures, the plunger 12 is in its projecting configuration in which the boss 16 projects from the plane of the outwardly facing surface 6.

As shown in FIG. 4, the lugs 22a, 22b, 22c engage a stop surface 26 defined by bottom portions of opposed walls of the plunger housing body 8a. This engagement between lugs 22a, 22b, 22c and the stop surfaces 26 limit the distance by which the boss 16 extends beyond the outwardly facing surface 6. Thus, the displacement of the plunger 12 relative to the plunger housing 8 is limited in one direction by the engagement of the stop surfaces 24 of the plunger body 14 and the stop elements 26 carried by the plunger housing body 8a; and is limited in the opposite direction by the engagement of the lugs 22a, 22b, 22c with the respective stop surfaces 26 defined by the plunger housing body 8a.

In order to assembly the plunger 12 and the end cap 2, the plunger 12 is aligned with the plunger housing 8 with the legs facing the housing 8. The plunger body 14 is then urged towards the housing 8. The lugs 22a, 22b, 22c then engage the plunger housing body 8a at the outwardly facing end of the housing 8. The shape of the lugs 22a, 22b, 22c cause the legs 20a, 20b, 20c to be deflected inwards until they are inserted into the plunger housing 8. When the lugs extend beyond the bottom of the housing body side walls, the lugs 22a, 22b, 22c are no longer urged inwards and the resiliently deformable legs 20a, 20b, 20c are able to spring back to their rest configuration.

As shown in FIG. 4, the plunger housing body 8a includes a pair of opposed end walls 8a′, 8a″. Fixed to each of the opposed end walls 8a′, 8a″ and extending between them is a leaf spring 28. The leaf spring 28 contacts the bottom of the spring contact element 18 such that when the plunger 12 is urged from its projecting configuration to a retracted configuration (in which the boss 16 is located within the plunger housing 8), a force is exerted by the spring contact element 18 on the leaf spring 28 which deflects the leaf spring 28. When the displacement force on the plunger 12 is removed, the restorative force exerted by the leaf spring 28 on the spring contact element 18 urges the plunger 12 back into its projecting configuration (as shown in FIG. 3).

FIG. 5 shows a cross-section through the combined end cap 2 and the plunger 12.

FIG. 6 shows a side elevational view of the combined end cap 2 and the plunger 12.

1. An end cap for a shading vane, the end cap including a plunger and a plunger housing; wherein the plunger is slidably coupled to the plunger housing, the plunger has a projecting configuration in which a boss portion of the plunger projects from the housing, and the plunger has a retracted configuration in which the boss portion of the plunger is located within the plunger housing; the plunger is biased towards the projecting configuration; the housing is defined by one or more housing walls; and wherein the plunger includes at least one leg; the or each leg includes a lug at a distal end thereof; and the or each lug engages a stop surface defined by one or more of the housing walls when the plunger is in its projecting configuration.

2. An end cap according to claim 1, wherein the boss portion of the plunger is cylindrical.

3. An end cap according to claim 1, wherein the end cap further includes a spring which provides the biasing force to the plunger.

4. An end cap according to claim 3, wherein the spring is a leaf spring.

5. An end cap according to claim 4, wherein the plunger housing includes opposed walls and the leaf spring is connected at one end to one of the opposed walls and is connected at its opposite end to the other of the opposed walls.

6. An end cap according to claim 1, wherein the plunger housing defines a rectangular cavity and the plunger is located within the cavity.

7. An end cap according to claim 6, wherein the plunger includes a rectangular body.

8. An end cap according to claim 7, wherein the boss portion of the plunger extends from one side of the rectangular body and the or each leg extends from the opposite side of the rectangular body.

9. An end cap according to claim 8, wherein the plunger includes a leg extending from at least one corner of the rectangular body.

10. A louvre or shutter vane including a main body portion, a first end cap at one end thereof and a second end cap at the opposite end thereof, wherein the first end cap includes a plunger and a plunger housing; wherein the plunger is slidably coupled to the plunger housing, the plunger has a projecting configuration in which a boss portion of the plunger projects from the housing, and the plunger has a retracted configuration in which the boss portion of the plunger is located within the plunger housing; the plunger is biased towards the projecting configuration; the housing is defined by one or more housing walls; and wherein the plunger includes at least one leg; the or each leg includes a lug at a distal end thereof; and the or each lug engages a stop surface defined by one or more of the housing walls when the plunger is in its projecting configuration.

11. A louvre or shutter vane according to claim 10, wherein the second end cap includes a fixed boss portion.

12. A shutter including a plurality of vanes and a pair of opposed vertical side elements, wherein each vane includes a main body portion, a first end cap at one end thereof and a second end cap at the opposite end thereof; the first end cap includes a plunger and a plunger housing; wherein the plunger is slidably coupled to the plunger housing, the plunger has a projecting configuration in which a boss portion of the plunger projects from the housing, and the plunger has a retracted configuration in which the boss portion of the plunger is located within the plunger housing; the plunger is biased towards the projecting configuration; the housing is defined by one or more housing walls; and wherein the plunger includes at least one leg; the or each leg includes a lug at a distal end thereof; and the or each lug engages a stop surface defined by one or more of the housing walls when the plunger is in its projecting configuration; and wherein the opposed vertical side elements each define a linear array of apertures; and a boss portion of the first end cap is located within an aperture defined by a first one of the vertical side elements and a boss portion of the second end cap is located within a corresponding aperture defined by a second one of the vertical side elements.

13. A shutter according to claim 12, wherein the second end cap includes a fixed boss portion.
